(19) United States
(12) Patent Application Publication
(10) Pub. No.: US 2023/0278040 A1
(43) Pub. Date: Sep. 7, 2023

(54) CRUSHER/PERFORATOR FOR RECYLCEABLE MATERIALS

(71) Applicant: Battelle Energy Alliance, LLC, Idaho Falls, ID (US)

(72) Inventors: Jeffrey A. Lacey, Ammon, ID (US); Blesson Isaac, Idaho Falls, ID (US)

(21) Appl. No.: 17/684,414

(22) Filed: Mar. 2, 2022

(51) Int. Cl. B02C 18/14

(52) U.S. Cl. CPC B02C 18/142; B02C 19/0093

(57) ABSTRACT

A system for perforating containers may have a first rotor assembly with a first set of rotors arranged at least partway along a first shaft, and a second rotor assembly with a second set of rotors arranged along a second shaft. The system may further have a frame that rotatably supports the first rotor assembly and the second rotor assembly in a parallel arrangement such that the first set of rotors interdigitates with the second set of rotors. Each rotor of the first set of rotors and the second set of rotors may have a hub, and one or more lobes extending outward from the hub, each of which is shaped such that, during rotation of the first rotor assembly and the second rotor assembly, the lobes perforate the containers as the containers pass between the first rotor assembly and the second rotor assembly.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates to systems and methods for preparing material for recycling. More precisely, this disclosure relates to a crusher/perforator that can crush and/or perforate containers such as bottles to facilitate cleansing prior to recycling.

### BACKGROUND

Millions of tons of plastics, metals, glass, and other materials are stored in landfills each year. New recycling solutions are needed to reduce waste and conserve new raw materials.

Many materials must be cleansed of contaminants before they can effectively be recycled. This poses a challenge for fluid containers such as bottles, as the residual fluid in the containers must be removed before recycling.

There is a need in the art for systems that can facilitate the removal of residual material from containers for recycling purposes.

### SUMMARY

The various devices, systems, and/or methods of the present disclosure have been developed in response to the present state of the art, and in particular, in response to the problems and needs in the art that have not yet been fully solved by currently available technology. As set forth above, many known recycling systems do not sufficiently process the material to be recycled. The system of the present disclosure may advantageously crush materials to be recycled to increase their bulk density. Further, the system may break glass containers so that they can be removed from the waste stream. Yet further, the system may perforate containers to further facilitate the recycling process by allowing liquids to drain. Many known recycling systems do not satisfactorily accomplish these objectives.

In some embodiments, a system for perforating containers may have a first rotor assembly with a first shaft and a first set of rotors arranged at least partway along a first length of the first shaft, and a second rotor assembly with a second shaft and a second set of rotors arranged at least partway along a second length of the second shaft. The system may further have a frame that rotatably supports the first rotor assembly and the second rotor assembly in a parallel arrangement such that the first set of rotors interdigitates with the second set of rotors. Each rotor of the first set of rotors and the second set of rotors may have a hub, and one or more lobes extending outward from the hub, each of which is shaped such that, during rotation of the first rotor assembly and the second rotor assembly, the lobes perforate the containers as the containers pass between the first rotor assembly and the second rotor assembly.

The system may further include a transmission that rotationally couples the first shaft with the second shaft such that the first shaft and the second shaft are constrained to rotate in opposite directions.

The system may further include a motor configured to drive rotation of the first rotor assembly and the second rotor assembly.

Each of the lobes of the rotors of the first rotor assembly may have a width similar to a spacing between adjacent hubs of the second rotor assembly such that, during rotation of the first rotor assembly and the second rotor assembly, shear force is applied to the containers by the lobes and hubs as the containers pass between the first rotor assembly and the second rotor assembly.

The first rotor assembly may further have a first set of spacers, each of which is between two adjacent rotors of the first set of rotors. The second rotor assembly may further have a second set of spacers, each of which is between two adjacent rotors of the second set of rotors. Each spacer of the first set of spacers and the second set of spacers may have a width similar to a width of each rotor of the first set of rotors and the second set of rotors.

The frame may have a first side plate parallel to the first shaft, a first set of baffles extending toward the first shaft from the first side plate such that each baffle of the first set of baffles extends between adjacent rotors of the first set of rotors, a second side plate parallel to the second shaft, and a second set of baffles extending toward the second shaft from the second side plate such that each baffle of the second set of baffles extends between adjacent rotors of the second set of rotors. Each baffle of the first set of baffles and the second set of baffles may have a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

The one or more lobes of each rotor may have at least three lobes.

Each of the first set of rotors and the second set of rotors may have a first end rotor, a second end rotor, and one or more middle rotors arranged between the first end rotor and the second end rotor. The lobes of the first end rotor and the second end rotor may be longer than the lobes of the one or more middle rotors.

Each of the lobes of the rotors of the first rotor assembly may have a narrow cutting tip, a leading surface extending from the hub to the narrow cutting tip, the leading surface having a concave shape, and a trailing surface extending from the hub to the narrow cutting tip.

According to some embodiments, a system for perforating containers may include a first rotor assembly with a first shaft and a first set of rotors arranged at least partway along a first length of the first shaft, and a second rotor assembly with a second shaft and a second set of rotors arranged at least partway along a second length of the second shaft. The system may further include a frame that rotatably supports the first rotor assembly and the second rotor assembly in a parallel arrangement such that the first set of rotors interdigitates with the second set of rotors. Each rotor of the first set of rotors and the second set of rotors may have a hub, and one or more lobes extending outward from the hub. Each of the lobes of the rotors of the first rotor assembly may have a width similar to a spacing between adjacent hubs of the second rotor assembly such that, during rotation of the first rotor assembly and the second rotor assembly, shear force is applied to the containers by the lobes and hubs as the containers pass between the first rotor assembly and the second rotor assembly.

The first rotor assembly may further have a first set of spacers, each of which is between two adjacent rotors of the first set of rotors. The second rotor assembly may further have a second set of spacers, each of which is between two adjacent rotors of the second set of rotors. Each spacer of the first set of spacers and the second set of spacers may have a width similar to a width of each rotor of the first set of rotors and the second set of rotors.

The frame may have a first side plate parallel to the first shaft, a first set of baffles extending toward the first shaft from the first side plate such that each baffle of the first set of baffles extends between adjacent rotors of the first set of rotors, a second side plate parallel to the second shaft, and a second set of baffles extending toward the second shaft from the second side plate such that each baffle of the second set of baffles extends between adjacent rotors of the second set of rotors. Each baffle of the first set of baffles and the second set of baffles may have a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

The one or more lobes of each rotor may be at least three lobes.

Each of the first set of rotors and the second set of rotors may have a first end rotor, a second end rotor, and one or more middle rotors arranged between the first end rotor and the second end rotor. The lobes of the first end rotor and the second end rotor may be longer than the lobes of the one or more middle rotors.

Each of the lobes of the rotors of the first rotor assembly mahy have a narrow cutting tip, a leading surface extending from the hub to the narrow cutting tip, the leading surface having a concave shape, and a trailing surface extending from the hub to the narrow cutting tip.

According to some embodiments, a system for perforating containers may have a first rotor assembly with a first shaft and a first set of rotors arranged at least partway along a first length of the first shaft, and a second rotor assembly with a second shaft and a second set of rotors arranged at least partway along a second length of the second shaft. The system may further have a frame that rotatably supports the first rotor assembly and the second rotor assembly in a parallel arrangement such that the first set of rotors interdigitates with the second set of rotors. Each rotor of the first set of rotors and the second set of rotors may have a hub and one or more lobes extending outward from the hub. Each of the lobes of the rotors of the first rotor assembly may have a narrow cutting tip, a leading surface extending from the hub to the narrow cutting tip, the leading surface having a concave shape, and a trailing surface extending from the hub to the narrow cutting tip.

The first rotor assembly may further have a first set of spacers, each of which is between two adjacent rotors of the first set of rotors. The second rotor assembly may further have a second set of spacers, each of which is between two adjacent rotors of the second set of rotors. Each spacer of the first set of spacers and the second set of spacers may have a width similar to a width of each rotor of the first set of rotors and the second set of rotors.

The frame may have a first side plate parallel to the first shaft, a first set of baffles extending toward the first shaft from the first side plate such that each baffle of the first set of baffles extends between adjacent rotors of the first set of rotors, a second side plate parallel to the second shaft, and a second set of baffles extending toward the second shaft from the second side plate such that each baffle of the second set of baffles extends between adjacent rotors of the second set of rotors. Each baffle of the first set of baffles and the second set of baffles may have a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

The one or more lobes of each rotor may be at least three lobes.

Each of the first set of rotors and the second set of rotors may include a first end rotor, a second end rotor, and one or more middle rotors arranged between the first end rotor and the second end rotor. The lobes of the first end rotor and the second end rotor may be longer than the lobes of the one or more middle rotors.

These and other features and advantages of the present technology will become more fully apparent from the following description and appended claims, or may be learned by the practice of the technology as set forth hereinafter

### BRIEF DESCRIPTION OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the scope of the appended claims, the exemplary embodiments of the present disclosure will be described with additional specificity and detail through use of the accompanying drawings in which:

FIG. 1 is a perspective view of a crusher/perforator according to one embodiment of the present disclosure;

FIG. 2 is another perspective view of the crusher/perforator of FIG. 1;

FIG. 3 is a top view of the crusher/perforator of FIG. 1;

FIG. 4 is a front view of the crusher/perforator of FIG. 1, with one end plate of the frame removed to provide a front view of the first rotor assembly the second rotor assembly;

FIG. 5 is a perspective view of a first rotor assembly and a second rotor assembly according to one alternative embodiment;

FIG. 6 is another perspective view of the first rotor assembly and the second rotor assembly of FIG. 5;

FIG. 7 is a front view of the first rotor assembly and the second rotor assembly of FIG. 5;

FIG. 8A is a front view of an end rotor of the first rotor assembly of FIG. 5;

FIG. 8B is a front view of a spacer of the first rotor assembly of FIG. 5; and

FIG. 8C is a front view of a middle rotor of the first rotor assembly of FIG. 5.

It is to be understood that the drawings are for purposes of illustrating the concepts of the disclosure and may not be drawn to scale. Furthermore, the drawings illustrate exemplary embodiments and do not represent limitations to the scope of the present disclosure.

### DETAILED DESCRIPTION

Exemplary embodiments of the present disclosure will be best understood by reference to the drawings, wherein like parts are designated by like numerals throughout. It will be readily understood that the components of the present disclosure, as generally described and illustrated in the drawings herein, could be arranged and designed in a wide variety of different configurations. Thus, the following more detailed description of the embodiments of the apparatus and method, as represented in the drawings, is not intended to limit the scope of the present disclosure, as claimed in this or any other application claiming priority to this application, but is merely representative of exemplary embodiments of the present disclosure.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The present disclosure discloses a crusher/perforator designed to perforate waste such as containers to facilitate removal of contaminants from their interior surfaces. The crusher/perforator may optionally be portable so that it can be used for small-scale recycling efforts. After perforation of waste containers, the containers may be immersed in a cleansing agent that removes contaminants from the interior surfaces of the containers, in preparation for recycling.

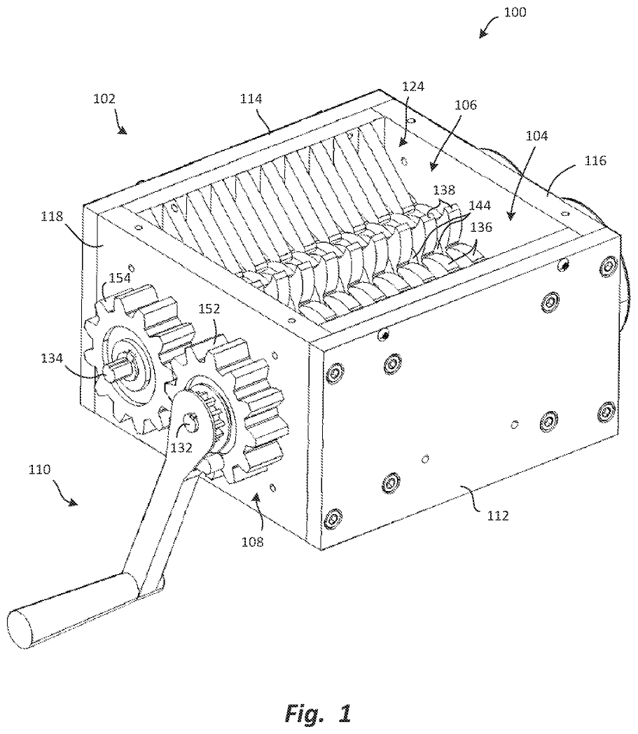

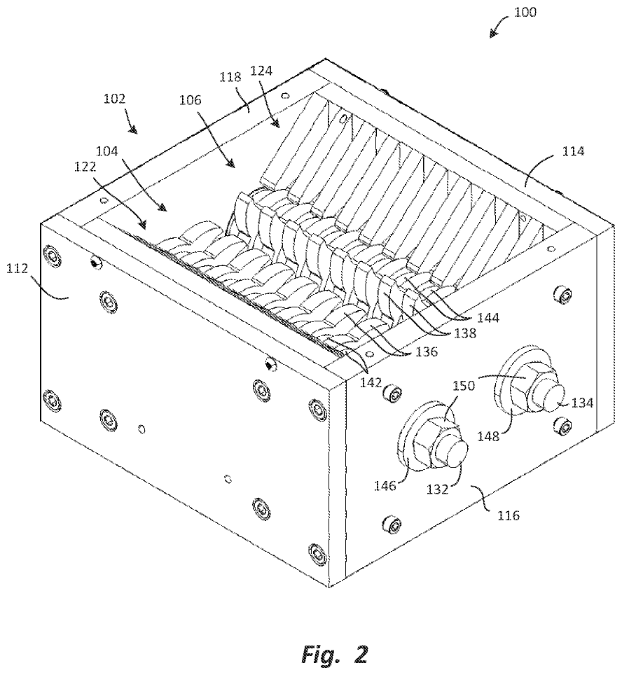

Referring to FIGS. 1 and 2, perspective views are shown of a crusher/perforator 100 according to one embodiment. The crusher/perforator 100 may receive feed stock dropped from above; the feed stock may include items made of plastic, glass, and/or metal, and associated food waste. The crusher/perforator 100 may be designed to perforate containers, in particular those made of plastic, to facilitate further cleansing steps. The crusher/perforator 100 may also crush waste items to a desired maximum thickness to further facilitate additional recycling steps.

The crusher/perforator 100 may have a frame 102 that supports a first rotor assembly 104 and a second rotor assembly 106 in a parallel arrangement such that items passing between the first rotor assembly 104 and the second rotor assembly 106 are perforated and crushed as described above. The first rotor assembly 104 and the second rotor assembly 106 may rotate in opposing directions to draw through material dropped into the crusher/perforator 100 from above. The frame 102 may retain the first rotor assembly 104 and the second rotor assembly 106 in a generally parallel arrangement.

The crusher/perforator 100 may further have a transmission 108 that constrains the first rotor assembly 104 and the second rotor assembly 106 to rotate at the same speed, in opposing directions, as mentioned above. In alternative embodiments, different transmissions may be used, such as a different gearing system, a belt drive, and/or the like. In alternative embodiments, a transmission may constrain the first rotor assembly 104 and the second rotor assembly 106 to rotate at different speeds.

The crusher/perforator 100 may also have a crank 110, which may act as a motor that drives rotation of the first rotor assembly 104 and the second rotor assembly 106 with human aid. In alternative embodiments, different types of motors may be used, such as a DC or AC electric motor, a gas-driven motor, and/or the like. In further alternative embodiments, the transmission 108 may be omitted, and separate motors may be provided to drive rotation of the first rotor assembly 104 and the second rotor assembly 106.

The frame 102 may have a first side plate 112, a second side plate 114, a first end plate 116, and a second end plate 118. The first rotor assembly 104 and the second rotor assembly 106 may be rotatably coupled to the first end plate 116 and the second end plate 118 via bearings, bushings, and/or other mechanical elements that facilitate relative rotation and/or reduce wear. In some embodiments, the frame 102 may be made lightweight to make the crusher/perforator 100 more portable. For example, the frame 102 may generally made of a lighter metal such as Aluminum. In some embodiments, even lighter materials such as plastics (for example, polyetheretherketone, or PEEK). In such embodiments, it may be desirable to have metal mechanical connections, such as sleeves, bearings, or bushings that are retained in the plastic material of the first end plate 116 and the second end plate 118.

The frame 102 may further have a first set of baffles 122 and a second set of baffles 124. The first set of baffles 122 may extend inward, toward the first rotor assembly 104, from the first side plate 112. Similarly, the second set of baffles 124 may extend inwardly from the second side plate 114, toward the second rotor assembly 106.

The first rotor assembly 104 may have a first shaft 132, and the second rotor assembly 106 may have a second shaft 134. The first rotor assembly 104 may further have a first set of rotors 136 arranged along at least part of its length. The first set of rotors 136 may be evenly-spaced apart such that each rotor resides between two adjacent baffles of the first set of baffles 122. Similarly, the second rotor assembly 106 may further have a second set of rotors 138 arranged along at least part of its length. The second set of rotors 138 may be evenly-spaced apart such that each rotor resides between two adjacent baffles of the second set of baffles 124. The rotors of the first set of rotors 136 may optionally be identical to the rotors of the second set of rotors 138, and may be in the same orientation on the first shaft 132 as the rotors of the second set of rotors 138 on the second shaft 134.

The first rotor assembly 104 may further have a first set of spacers 142 arranged along at least part of its length, such that each spacer is between an adjacent pair of rotors of the first set of rotors 136. Similarly, the second rotor assembly 106 may further have a second set of spacers 144 arranged along at least part of its length, such that each spacer is between an adjacent pair of rotors of the second set of rotors 138.

The rotors and spacers of the first set of rotors 136, the second set of rotors 138, the first set of spacers 142, and the second set of spacers 144 may be coupled to the first shaft 132 and the second shaft 134, respectively, according to any methods known in the art, including but not limited to insertion of noncircular (for example, hexagonal) cross sections (not shown) of the first shaft 132 and the second shaft 134 through correspondingly shaped holes in the rotors and spacers.

As shown in FIG. 2, a first set of bearings 146 (only one of which is visible) may be used to rotatably couple the first shaft 132 to the first end plate 116 and the second end plate 118. Similarly, a second set of bearings 148 (only one of which is visible) may be used to rotatably couple the second shaft 134 to the first end plate 116 and the second end plate 118. The first set of bearings 146 and the second set of bearings 148 are optional and in some embodiments, may be omitted and/or replaced with alternative elements such as bushings.

Further, the first shaft 132 and the second shaft 134 may be retained in the first end plate 116 through the use of fasteners 150, such as the nuts shown in FIG. 2. In alternative embodiments, other fastening devices may be used as known in the art, including but not limited to nuts, bolts, clamps, crimped or swaged devices and/or other fasteners. The first shaft 132 and the second shaft 134 may optionally have threaded ends designed to receive the fasteners 150. The transmission 108 may have a first gear 152 secured to the opposite end of the first shaft 132, and a second gear 154 secured to the opposite end of the second gear 154. The first gear 152 may mesh with the second gear 154 such that the first shaft 132 and the second shaft 134 are constrained to rotate in opposite directions, at the same speed. Thus, the crank 110 may be secured to only one of the first shaft 132 and the second shaft 134 (for example, to the first shaft 132), but may be used to rotate both the first shaft 132 and the second shaft 134.

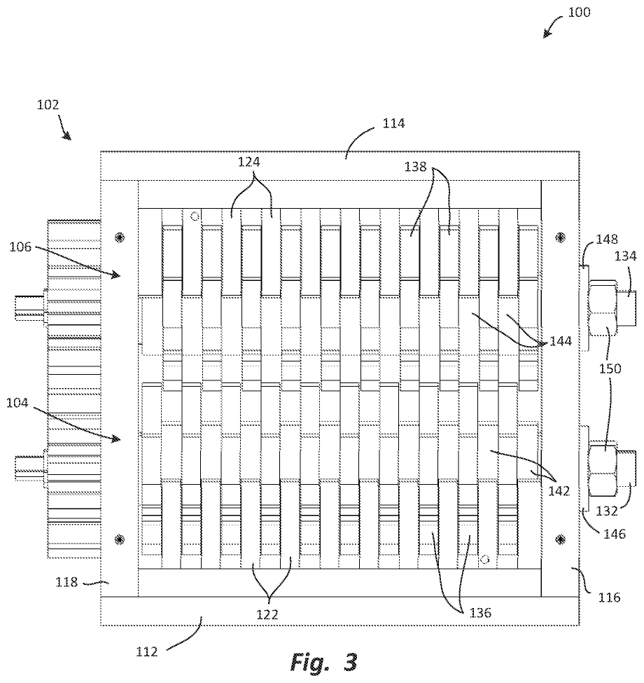

Referring to FIG. 3, a top view of the crusher/perforator 100 of FIG. 1 is shown. FIG. 3 illustrates the manner in which the first rotor assembly 104, the second rotor assembly 106, the first set of baffles 122, and the second set of baffles 124 mesh together. As shown, each of the rotors, baffles, and spacers of the first set of rotors 136, the second set of rotors 138, the first set of baffles 122, the second set of baffles 124, the first set of spacers 142, and the second set of spacers 144 may have approximately the same width. Thus, the first set of rotors 136 may mesh relatively tightly with the second set of rotors 138 and the first set of baffles 122. Similarly, the second set of rotors 138 may mesh relatively tightly with the first set of rotors 136 and the second set of baffles 124. “Relatively tight” meshing refers to moving parts that are dimensioned and positioned such that they move relative to each other with minimal clearance, no clearance, or even interference, like the blades of a pair of scissors.

As shown in FIG. 3, the rotors of the first rotor assembly 104 and the rotors of the second rotor assembly 106 may each extend across the central plane (midway between the first side plate 112 and the second side plate 114) such that there is some overlap between the lobes of the first rotor assembly 104 and those of the second rotor assembly 106. This overlap may be relatively small, for example, 0 to 10 millimeters. More specifically, the overlap may be 1 to 5 millimeters. Still more precisely, the overlap may be 2 or 3 millimeters.

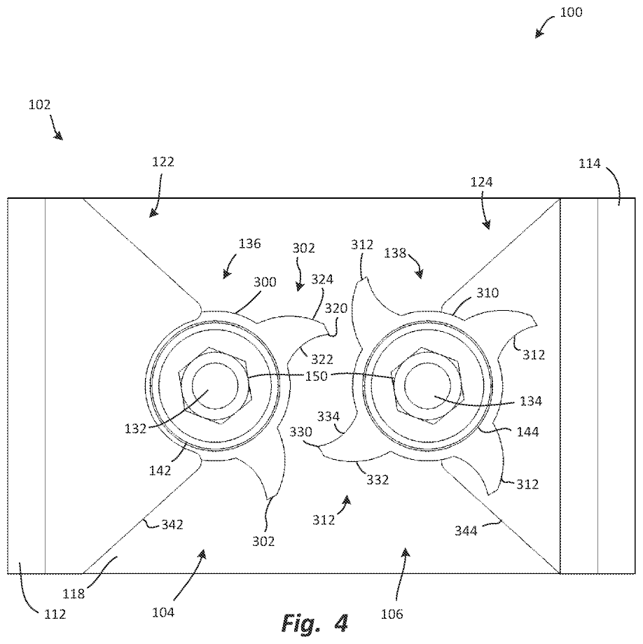

This relatively tight intermeshing may promote shearing action between the first set of rotors 136 and the second set of rotors 138. This shearing action (like a pair of scissors) may help to create several perforations in a container, such as bottle, being drawn through the crusher/perforator 100, between the first rotor assembly 104 and the second rotor assembly 106. Further, this relatively tight intermeshing may promote removal of material adhering to the rotors. Specifically, as the outer elements of the rotors of the first rotor assembly 104 and the second rotor assembly 106 rotate into the space between the baffles of the first set of baffles 122 and the second set of baffles 124, respectively, matter adhered to the rotors may be knocked loose as it comes into contact with the baffles. These concepts will be shown and described in greater detail in connection with FIG. 4.

Referring to FIG. 4, a front view of the crusher/perforator of FIG. 1 is shown, with the first end plate 116 of the frame 102 removed to provide a front view of the first rotor assembly 104 the second rotor assembly 106. Front views are also shown of the first set of baffles 122, the second set of baffles 124, the first set of rotors 136, the second set of rotors 138, the first set of spacers 142, and the second set of spacers 144. The first rotor assembly 104 may rotate clockwise, and the second rotor assembly 106 may rotate counterclockwise, in the view of FIG. 4.

As shown, each rotor of the first set of rotors 136 may have a hub 300 with a generally discoid shape, and lobes 302 extending outwardly from the hub 300. Similarly, each rotor of the second set of rotors 138 may have a hub 310 with a generally discoid shape, and lobes 312 extending outwardly from the hub 310. FIG. 4 illustrates the presence of four of the lobes 302 on each hub 300, and four of the lobes 312 on each hub 310. However, any number of lobes may be present. For example, the number lobes may range from 1 to 10. More precisely, the number of lobes may range from 2 to 8. Yet more precisely, the number of lobes may range from 3 to 6. Still more precisely, the number of lobes may be 4 as shown. In some embodiments, the number of lobes may be varied based on the size of material to be processed, the speed at which the first rotor assembly 104 and the second rotor assembly 106 are to rotate, the shape of the lobes, and/or other factors.

Each of the lobes 302 may have a hooked shape, with a cutting tip 320 with a sharpened shape configured to puncture containers of the type that will be processed by the crusher/perforator 100. Each of the lobes 302 may further have a leading surface 322 with a generally concave shape, and a trailing surface 324 with a generally convex shape. The shapes of the leading surface 322 and the trailing surface 324 may provide the hooked shape. The concave shape of the leading surface 322 may help capture material to be perforated and/or crushed, and draw the material into the space between the first rotor assembly 104 and the second rotor assembly 106 so that it will be crushed, perforated, and dropped into a receptacle (not shown) beneath the crusher/perforator 100.

Each of the lobes 312 may also have a hooked shape, with a cutting tip 330 with a sharpened shape configured to puncture containers of the type that will be processed by the crusher/perforator 100. Each of the lobes 312 may further have a leading surface 332 with a generally convex shape, and a trailing surface 334 with a generally concave shape. The shapes of the leading surface 332 and the trailing surface 334 may provide the hooked shape. The convex shape of the leading surface 332 may help perforate the material and/or drive the material toward the first rotor assembly 104 so that it can be captured by virtue of the concave shape of the leading surface 322 of each of the rotors of the first rotor assembly 104, as described above.

The shearing effect described above may occur as material is pressed between the cutting tip 320 and/or the leading surface 322 of each of the lobes 302 of each rotor of the first rotor assembly 104, and the hub 310 of each adjacent rotor of the second rotor assembly 106. Additionally, this shearing effect may occur as material is pressed between the cutting tip 330 and/or the leading surface 332 of each of the lobes 312 of each rotor of the second rotor assembly 106, and the hub 300 of each adjacent rotor of the first rotor assembly 104. If desired, the leading, outer edges of the leading surface 322, the leading surface 332, the hub 300, and/or the hub 310 may be squared and/or sharpened in order to enhance this shearing action.

The first set of baffles 122, the second set of baffles 124, the first set of rotors 136, the second set of rotors 138, the first set of spacers 142, and/or the second set of spacers 144 may, in some embodiments, be made of hard, wear-resistant materials in order to enhance this shearing action and maintain it over time. For example, these components may be made of tool steel, Titanium, and/or the like.

As also shown, the first rotor assembly 104 and the second rotor assembly 106 may be oriented such that each of the lobes 302 of the first rotor assembly 104 is rotationally offset, about the first shaft 132, from each of the lobes 312 of the second rotor assembly 106. Thus, the lobes 302 of the first rotor assembly 104 may not pass through the central plane through the axes of the first shaft 132 and the second shaft 134 at the same time as the lobes 312 of the second rotor assembly 106. Rather, this passage may be staggered (with one of the lobes 302 of the first rotor assembly 104 passing through the plane, then one of the lobes 312 of the second rotor assembly 106, and then another of the lobes 302 of the first rotor assembly 104, and so on). This staggered placement may help to ensure that material does not pass between the first rotor assembly 104 and the second rotor assembly 106 without being perforated by the lobes 302 of the first rotor assembly 104 and/or the lobes 312 of the second rotor assembly 106.

As further shown in FIG. 4, each baffle of the first set of baffles 122 may have a first cleaning surface 342 that is generally downwardly oriented. Similarly, the second set of baffles 124 may have a second cleaning surface 344 that is also generally downwardly oriented. The lobes 302 and the lobes 312 may rotate such that they move downward proximate the center plane of the crusher/perforator 100 (midway between the first side plate 112 and the second side plate 114), perforating material as described above, and then rotate outward toward the first side plate 112 and the second side plate 114, and move upward again. During this upward motion, material carried on the lobes 302 and the lobes 312 may be knocked and/or sheared off of the lobes 302 and the lobes 312 as the material comes into contact with the first cleaning surface 342 and the second cleaning surface 344, respectively.

The crusher/perforator 100 of FIGS. 1 through 4 is only one of many crusher/perforator designs that may be used within the scope of the present disclosure. Various aspects of the frame 102, the first rotor assembly 104, the second rotor assembly 106, the transmission 108, and the crank 110 may be modified, omitted, and/or replaced with different versions, as would be envisioned by a person of skill in the art.

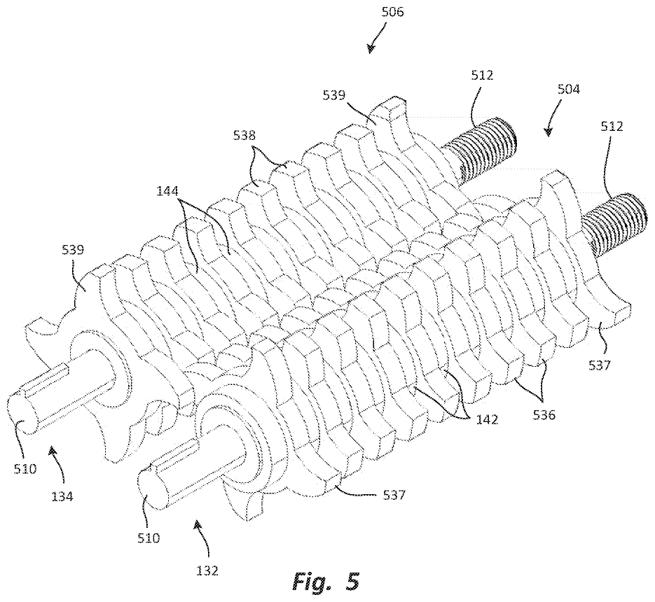

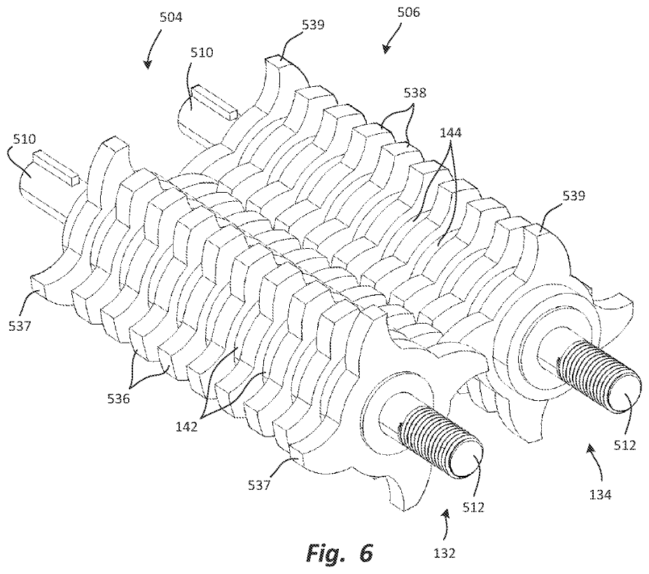

Referring to FIGS. 5 and 6, two perspective views show a first rotor assembly 504 and a second rotor assembly 506 according to one alternative embodiment. The first rotor assembly 504 and the second rotor assembly 506 may be used in connection with a frame 102, transmission 108, and crank 110 as disclosed in connection with the crusher/perforator 100 above, or with any suitable alternative. As shown, the first rotor assembly 504 and the second rotor assembly 506 may be generally similar to the first rotor assembly 104 and the second rotor assembly 106, respectively, with some differences, which will be described below.

The first rotor assembly 504 and the second rotor assembly 506 may include the first shaft 132 and the second shaft 134, which may be configured as in the first rotor assembly 104 and the second rotor assembly 106. As shown, each of the first shaft 132 and the second shaft 134 may have a keyed end 510 and a threaded end 512. The keyed end 510 may be designed to receive torque from a transmission and/or motor, such as the transmission 108 and/or the crank 110 of the crusher/perforator 100. The threaded end 512 may have threads that receive fasteners such as the fasteners 150 of the crusher/perforator 100.

As shown, the first rotor assembly 504 may have middle rotors 536 and end rotors 537, which may be shaped somewhat differently from the middle rotors 536. Similarly, the second rotor assembly 506 may have middle rotors 538 and end rotors 539, which may be shaped somewhat differently from the middle rotors 538. The end rotors 537 and the end rotors 539 may have longer lobes, than the middle rotors 536 and the middle rotors 538, as will be shown and described in greater detail subsequently. The end rotors 537 may optionally be identical to the end rotors 539, but rotated 180° about a vertical axis. Similarly, the middle rotors 536 may optionally be identical to the middle rotors 538, but rotated 180° about a vertical axis.

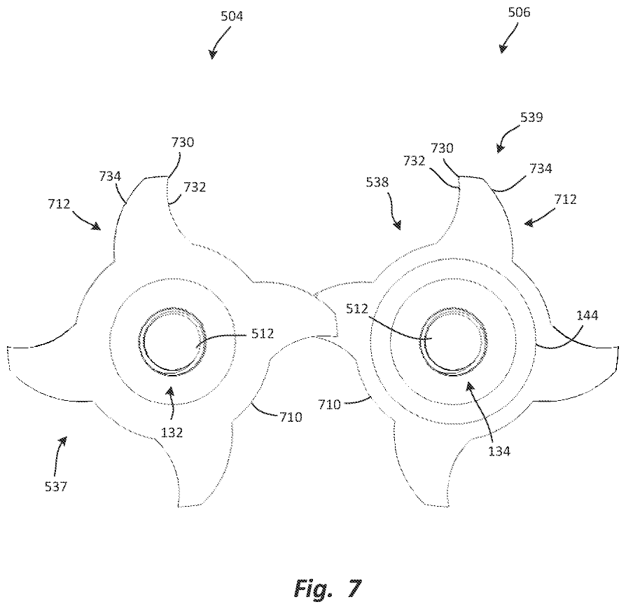

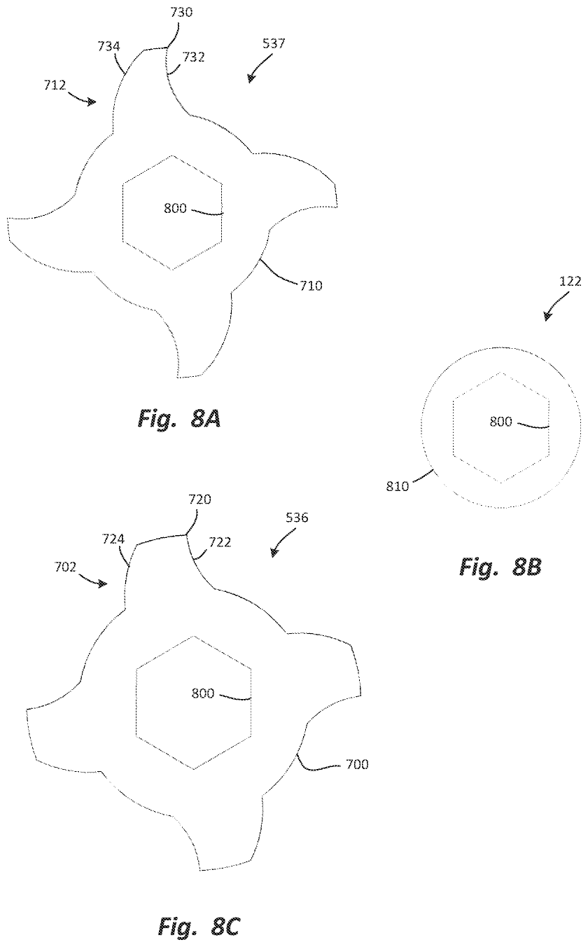

Referring to FIGS. 7 through 8C, FIG. 7 is a front view of the first rotor assembly 504 and the second rotor assembly 506 of FIG. 5. FIG. 8A is a front view of one of the end rotors 537 of the first rotor assembly 504 of FIG. 5. FIG. 8B is a front view of a spacer 142 of the first rotor assembly 504 of FIG. 5. FIG. 8C is a front view of a middle rotor 536 of the first rotor assembly 504 of FIG. 5.

In FIG. 7, the closest of the end rotors 537 occludes the middle rotors 536 and the first set of spacers 142 of the first rotor assembly 504. On the second rotor assembly 506, one of the second set of spacers 144 is visible in front of the closest of the end rotors 539, which occludes the middle rotors 538. As shown, each of the end rotors 537 and the end rotors 539 may have a hub 710 and a plurality of lobes 712 extending from the hub 710. Similarly, as shown in FIG. 8C, each of the middle rotors 536 may have a hub 700 with a plurality of lobes 702 extending from the hub 700.

Returning to FIG. 7, like the lobes 312 of the crusher/perforator 100, each of the lobes 712 of the end rotors 537 may have a hooked shape, with a cutting tip 730 with a sharpened shape configured to puncture containers of the type that will be processed. Each of the lobes 712 may further have a leading surface 732 with a generally concave shape, and a trailing surface 734 with a generally convex shape. The shapes of the leading surface 732 and the trailing surface 734 may provide the hooked shape. The concave shape of the leading surface 732 may help capture material to be perforated and/or crushed, and draw the material into the space between the first rotor assembly 504 and the second rotor assembly 506 so that it will be crushed, perforated, and dropped into a receptacle (not shown) beneath the first rotor assembly 504 and the second rotor assembly 506.

FIG. 8C shows one of the middle rotors 536 of the first rotor assembly 504. Like the end rotors 537, each of the middle rotors 536 may have a hooked shape, with a cutting tip 720 with a sharpened shape configured to puncture containers of the type that will be processed. Each of the lobes 702 may further have a leading surface 722 with a generally concave shape, and a trailing surface 724 with a generally convex shape. The shapes of the leading surface 722 and the trailing surface 724 may provide the hooked shape. The concave shape of the leading surface 722 may help capture material to be perforated and/or crushed, and draw the material into the space between the first rotor assembly 504 and the second rotor assembly 506.

As mentioned before, the middle rotors 538 of the second rotor assembly 506 may be identical to the middle rotors 536 of the first rotor assembly 504, and the end rotors 539 of the second rotor assembly 506 may be identical to the end rotors 537 of the first rotor assembly 504. Thus, each of the middle rotors 538 and the end rotors 539 may have a hub 700 or a hub 710, and lobes 702 or lobes 712 as applicable, as described above.

Notably, the lobes 712 of the end rotors 537 may be longer than the lobes 702 of the middle rotors 536. This difference in length may help to overcome the tendency of material to gather at the ends of the first rotor assembly 504 and the second rotor assembly 506 (for example, close to the first end plate 116 and the second end plate 118, if present). The elongation of the lobes 712 relative to the lobes 702 may cause the lobes 712 to draw material through the space between the first rotor assembly 504 and the second rotor assembly 506 more aggressively, avoiding this buildup. Additionally or alternatively, the elongation of the lobes 712 relative to the lobes 702 may cause the lobes 712 to urge material to move inward (for example, away from the first end plate 116 and the second end plate 118, if present) to reduce accumulation at the ends of the first rotor assembly 504 and the second rotor assembly 506.

Also, as shown in FIGS. 5, 6, and 7, and described above, the leading surface 722 and the leading surface 732 of all of the middle rotors 536 and the end rotor 537 of the first rotor assembly 504, and the middle rotors 538 and the end rotors 539 of the second rotor assembly 506, may be concave. This concavity may help the first rotor assembly 504 and the second rotor assembly 506 draw material into the space between the first rotor assembly 504 and the second rotor assembly 506, where it can be crushed and/or perforated in preparation for recycling.

Yet further, the first rotor assembly 504 and the second rotor assembly 506 may be oriented such the lobes 702 and the lobes 712 of the first rotor assembly 504 are rotationally synchronized with their counterparts of the second rotor assembly 506. Thus, the lobes 702 and the lobes 712 of the first rotor assembly 504 may pass through the central plane through the axes of the first shaft 132 and the second shaft 134 at the same time as the lobes 702 and the lobes 712 of the second rotor assembly 506. This synchronized rotation may help apply greater perforating force on material captured by the lobes 702 and/or the lobes 712 as it passes between the first rotor assembly 504 and the second rotor assembly 506.

FIGS. 8A, 8B, and 8C further illustrate the presence of a hexagonal hole 800 in the center of each of the middle rotors 536, the end rotor 537, and the spacer 142 of the first rotor assembly 504. The middle rotors 538, the end rotors 539, and the spacers 144 of the second rotor assembly 506 may be identical to these as mentioned previously.

As further shown in FIG. 8B, each spacer of the first set of spacers 142 may have a rim 810 that defines a size smaller than that of the hub 700 of each of the middle rotors 536 and of the hub 710 of each of the end rotor 537. Thus, the rim 810 of each of the spacers 142 may receive contact only from material that protrudes into the space between the adjacent rotors.

Many variations may be envisioned for each of the middle rotors 536, the end rotor 537, and the spacer 142. In some alternative embodiments, the dimensions of these components may be adjusted to provide a desired level of compression, perforation, and/or breakage of glass material, to adjust the level of torque required for crushing/perforation, modify the maximum thickness of processed material, and/or accomplish other objectives. For example, the diameters of the rims 810 of the spacers 142 can be increased to reduce the maximum thickness of the processed material and increase the required input torque, or reduced to reduce the required input torque and increase the maximum thickness of the processed material.

In addition to or in the alternative to modifying the diameters of the spacers 142, the diameters of the hubs 700 of the middle rotors 536 and/or the diameters of the hubs 710 of the end rotors 537 may be modified to adjust the maximum thickness of processed material and/or the input torque. Each of the hubs 700 and the hubs 710 is aligned with a spacer 142, so the diameter of either, or both, can be adjusted to control the space available for material to pass between the first rotor assembly 504 and the second rotor assembly 506.

In addition to or in the alternative to the foregoing, the lengths and/or shapes of the lobes 702 of the middle rotors 536 and/or the lobes 712 of the end rotors 537 may be modified to adjust the required input torque and/or the length and depth of perforations. Longer and/or more aggressively shaped lobes 702 and lobes 712 may provide longer, deeper perforations and may require increased input torque. Conversely, shorter and/or less aggressively shaped loves 702 and lobes 712 may provide shorter, shallower perforations and may require less input torque.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified. Further, steps may be omitted, replaced with other steps, and/or supplemented with additional steps not specifically described, as would be envisioned by a person of skill in the art with the aid of the present disclosure.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the methods and systems of the present disclosure set forth herein without departing from it spirit and scope.

What is claimed is:

1. A system for perforating containers, the system comprising:
a first rotor assembly comprising:
a first shaft; and
a first set of rotors arranged at least partway along a first length of the first shaft; and
a second rotor assembly comprising:
a second shaft; and
a second set of rotors arranged at least partway along a second length of the second shaft; and
a frame that rotatably supports the first rotor assembly and the second rotor assembly in a parallel arrangement such that the first set of rotors interdigitates with the second set of rotors;
wherein each rotor of the first set of rotors and the second set of rotors comprises:
a hub; and
one or more lobes extending outward from the hub, wherein each of the lobes is shaped such that, during rotation of the first rotor assembly and the second rotor assembly, the lobes perforate the containers as the containers pass between the first rotor assembly and the second rotor assembly.

2. The system of claim 1, further comprising a transmission that rotationally couples the first shaft with the second shaft such that the first shaft and the second shaft are constrained to rotate in opposite directions.

3. The system of claim 2, further comprising a motor configured to drive rotation of the first rotor assembly and the second rotor assembly.

4. The system of claim 1, wherein each of the lobes of the rotors of the first rotor assembly has a width similar to a spacing between adjacent hubs of the second rotor assembly such that, during rotation of the first rotor assembly and the second rotor assembly, shear force is applied to the containers by the lobes and hubs as the containers pass between the first rotor assembly and the second rotor assembly.

5. The system of claim 4, wherein:
the first rotor assembly further comprises a first set of spacers, each of which is between two adjacent rotors of the first set of rotors; and
the second rotor assembly further comprises a second set of spacers, each of which is between two adjacent rotors of the second set of rotors; and
each spacer of the first set of spacers and the second set of spacers has a width similar to a width of each rotor of the first set of rotors and the second set of rotors.

6. The system of claim 1, wherein the frame comprises:
a first side plate parallel to the first shaft;
a first set of baffles extending toward the first shaft from the first side plate such that each baffle of the first set of baffles extends between adjacent rotors of the first set of rotors;
a second side plate parallel to the second shaft; and
a second set of baffles extending toward the second shaft from the second side plate such that each baffle of the second set of baffles extends between adjacent rotors of the second set of rotors;
wherein each baffle of the first set of baffles and the second set of baffles has a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

7. The system of claim 1, wherein the one or more lobes of each rotor comprises at least three lobes.

8. The system of claim 1, wherein each of the first set of rotors and the second set of rotors comprises:
a first end rotor;
a second end rotor; and
one or more middle rotors arranged between the first end rotor and the second end rotor;
wherein the lobes of the first end rotor and the second end rotor are longer than the lobes of the one or more middle rotors.

9. The system of claim 1, wherein each of the lobes of the rotors of the first rotor assembly comprises:
a narrow cutting tip;
a leading surface extending from the hub to the narrow cutting tip, the leading surface having a concave shape; and
a trailing surface extending from the hub to the narrow cutting tip.

10. A system for perforating containers, the system comprising:
a first rotor assembly comprising:
a first shaft; and
a first set of rotors arranged at least partway along a first length of the first shaft; and
a second rotor assembly comprising:
a second shaft; and
a second set of rotors arranged at least partway along a second length of the second shaft; and
a frame that rotatably supports the first rotor assembly and the second rotor assembly in a parallel arrangement such that the first set of rotors interdigitates with the second set of rotors;
wherein each rotor of the first set of rotors and the second set of rotors comprises:
a hub; and
one or more lobes extending outward from the hub, wherein each of the lobes of the rotors of the first rotor assembly has a width similar to a spacing between adjacent hubs of the second rotor assembly such that, during rotation of the first rotor assembly and the second rotor assembly, shear force is applied to the containers by the lobes and hubs as the containers pass between the first rotor assembly and the second rotor assembly.

11. The system of claim 9, wherein:
the first rotor assembly further comprises a first set of spacers, each of which is between two adjacent rotors of the first set of rotors; and
the second rotor assembly further comprises a second set of spacers, each of which is between two adjacent rotors of the second set of rotors; and
each spacer of the first set of spacers and the second set of spacers has a width similar to a width of each rotor of the first set of rotors and the second set of rotors.

12. The system of claim 9, wherein the frame comprises:
a first side plate parallel to the first shaft;
a first set of baffles extending toward the first shaft from the first side plate such that each baffle of the first set of baffles extends between adjacent rotors of the first set of rotors;
a second side plate parallel to the second shaft; and
a second set of baffles extending toward the second shaft from the second side plate such that each baffle of the second set of baffles extends between adjacent rotors of the second set of rotors;
wherein each baffle of the first set of baffles and the second set of baffles has a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

13. The system of claim 9, wherein the one or more lobes of each rotor comprises at least three lobes.

14. The system of claim 9, wherein each of the first set of rotors and the second set of rotors comprises:
a first end rotor;
a second end rotor; and
one or more middle rotors arranged between the first end rotor and the second end rotor;
wherein the lobes of the first end rotor and the second end rotor are longer than the lobes of the one or more middle rotors.

15. The system of claim 9, wherein each of the lobes of the rotors of the first rotor assembly comprises:
a narrow cutting tip;
a leading surface extending from the hub to the narrow cutting tip, the leading surface having a concave shape; and
a trailing surface extending from the hub to the narrow cutting tip.

16. A system for perforating containers, the system comprising:
a first rotor assembly comprising:
a first shaft; and
a first set of rotors arranged at least partway along a first length of the first shaft; and
a second rotor assembly comprising:
a second shaft; and
a second set of rotors arranged at least partway along a second length of the second shaft; and
a frame that rotatably supports the first rotor assembly and the second rotor assembly in a parallel arrangement such that the first set of rotors interdigitates with the second set of rotors;
wherein each rotor of the first set of rotors and the second set of rotors comprises:
a hub; and
one or more lobes extending outward from the hub, wherein each of the lobes of the rotors of the first rotor assembly comprises:
a narrow cutting tip;
a leading surface extending from the hub to the narrow cutting tip, the leading surface having a concave shape; and
a trailing surface extending from the hub to the narrow cutting tip.

17. The system of claim 16, wherein:
the first rotor assembly further comprises a first set of spacers, each of which is between two adjacent rotors of the first set of rotors; and
the second rotor assembly further comprises a second set of spacers, each of which is between two adjacent rotors of the second set of rotors; and
each spacer of the first set of spacers and the second set of spacers has a width similar to a width of each rotor of the first set of rotors and the second set of rotors.

18. The system of claim 16, wherein the frame comprises:
a first side plate parallel to the first shaft;
a first set of baffles extending toward the first shaft from the first side plate such that each baffle of the first set of baffles extends between adjacent rotors of the first set of rotors;
a second side plate parallel to the second shaft; and
a second set of baffles extending toward the second shaft from the second side plate such that each baffle of the second set of baffles extends between adjacent rotors of the second set of rotors;
wherein each baffle of the first set of baffles and the second set of baffles has a width similar to a spacing between adjacent rotors of the first set of rotors and the second set of rotors such that, during rotation of the first rotor assembly and the second rotor assembly, material carried upward by the lobes is further perforated and/or removed from the lobes by the first set of baffles and the second set of baffles.

19. The system of claim 16, wherein the one or more lobes of each rotor comprises at least three lobes.

20. The system of claim 16, wherein each of the first set of rotors and the second set of rotors comprises:
a first end rotor;
a second end rotor; and
one or more middle rotors arranged between the first end rotor and the second end rotor;
wherein the lobes of the first end rotor and the second end rotor are longer than the lobes of the one or more middle rotors.
